(19) United States
(12) Patent Application Publication
(10) Pub. No.: US 2007/0094097 A1
(43) Pub. Date: Apr. 26, 2007

(54) System and method for secured authorized user-initiated transactions

(76) Inventors: Fori Owurowa, Redondo Beach, CA (US); Paula Lynn Comensky-Owurowa, Redondo Beach, CA (US)

Correspondence Address: Paula Comensky-Owurowa, 1912-B Perry Ave., Redondo Beach, CA, 90278, US

(21) Appl. No.: 11/581,955

(22) Filed: Oct. 17, 2006

Related U.S. Application Data
(60) Provisional application No. 60/729,327, filed on Oct. 21, 2005.

(51) Int. Cl. G06Q 30/00

(52) U.S. Cl. 705/26

(57) ABSTRACT

A universal, secure hardware/software system and method that allows a customer to be in control of a transaction, grant or deny access to charge a credit card, or gain access to an internet or internet account. The embodiments provide a verification process that validates the user's identity and prevents unauthorized access of the customer's credit card.

This patent application claims the benefit of the filing date of provisional patent application No. 60,729,327, filed on Oct. 21, 2005.

### BACKGROUND

1. Field of the Invention

The embodiments herein generally relate to electronic transactions, and more particularly to systems and methods for providing fraud protection and transaction security.

2. Description of the Related Art

Typically, in a credit card transaction customers provide merchants with their credit card numbers in order to make a purchase. These transactions can occur in person, over the telephone through the mail/fax, or on the internet, for example. Once the credit card number is divulged, there is scant protection for the customer in the case of a third party stealing the credit card number and using it for fraudulent purchases. Usually when fraud takes place online, the costumer will not even know an unauthorized use has occurred until they receive their statement the following month, or if the credit card company has an activity monitoring service, a representative will contact the credit card holder where questionable purchases are being made with the credit card. Often, it is the credit card company who must bear the burden/expense of fraudulent purchases on one of their customer's credit card accounts. Such a burden is often passed on to customer via increased interest rates and/or increased annual fees for using the credit card. Accordingly, there remains a need to solve the problems of unauthorized and fraudulent card charging, both on the internet and at the point of sale; unsecured distribution of credit card numbers; charging credit cards for an incorrect amount; unauthorized access to internet servers and accounts; poor consumer confidence in the security of buying things on internet; and identity theft. In other words, there remains a need for a new system and method that can provide an added level of security to credit card transactions, particularly web-based transactions.

### SUMMARY

The embodiments herein provide a universal, secure hardware/software system and method that allows a customer to be in control of a transaction, grant or deny access to charge a credit card, or gain access to an internet or intranet account. The embodiments provide a verification process that validates the user's identity and prevents unauthorized access of the customer's credit card.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIGS. 1 and 2 illustrate flow diagrams illustrating a preferred method according to an embodiment herein; and

FIG. 3 illustrates a computer diagram according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments provide a universal, secure hardware/software system that allows a customer to be in control of a transaction, grant or deny access to charge a credit card, or gain access to an internet or intranet account. The embodiments provide a verification process that validates the user's identity and prevents unauthorized access by electronically asking the legal owner of the information, “Is this you?” This verification process occurs on the valid user's webpage, or may be sent to the user's handheld receiving device (i.e., cell phone, PDA, etc.) as an encrypted text message. From the user's point of view, there is no time deadline in which to respond.

The system and method embodiments allow for an added level of security when it comes to consumer based transactions. As previously mentioned, usually when fraud takes place online, the customer won't even know until they get their statement the following month. With the embodiments herein, the customer will know right away if there are any suspicious charges because the customer will have access to all transactions at anytime on a website provided by the embodiments (referred to as the SecureBIT website). This extra level of security will allow consumers who felt uneasy about purchasing on the internet because of fraud, to perform transactions online with confidence.

The process begins with a customer signing up for a new account on the SecureBIT website and receiving an identifier number, known as the “SecureBIT number.” The SecureBIT number may be selected at random by the SecureBIT website. The SecureBIT number may comprise any type of characters such as numbers, letters, symbols, etc., and may include any number of such characters (i.e., 16 digit code, for example). Moreover, the SecureBIT number could appear on the credit card itself
Step 1: Using a computer, cell phone, or PDA, a customer goes to a merchant's website to purchase a product or service.
Step 2: When the customer is ready to make his purchase, he clicks the “buy” button (or other comparable button/link) and proceeds to the merchant's shopping cart to checkout.
Step 3: Customer enters his SecureBIT number on the shopping cart page of the merchant's website for processing, instead of a credit card number.
Step 4: Merchant's website sends encrypted information to the SecureBIT website server for an approval request using the standard secure socket layer (SSL) certificate. This information includes the merchant number, the total dollar amount of the transaction, and the customer's SecureBIT number. The merchant number is assigned by a bank to a merchant and is similar to the merchant number currently assigned to merchants who accept credit cards for payment.
Step 5:: SecureBIT website server receives the request and information from the merchant's website, the SecureBIT system software decrypts the information, and searches the database for a matching customer account to the SecureBIT number it received. Upon finding a matching account, the information received is stored as a new transaction record in the customer's account, and can now be displayed for the customer when they log onto their SecureBIT account webpage. The embodiments herein can send an e-mail notification to customer when an approval request has been placed by a merchant for a transaction.
Step 6: Customer logs onto their SecureBIT page from any computer at any time, sees the pending transaction, and is able to accept or decline it with the click of the mouse using the SecureBIT system software interface. All customers have their own unique SecureBIT webpage that they can log onto at any time.
Step 7: If the customer declines a transaction on their SecureBIT account page, the SecureBIT system software will send a decline response to the merchant. If the customer accepts a transaction, they can choose to use any verified credit card, and proceed with the transaction, using their SecureBIT account checkout page. If the customer chooses to, they can store credit card information on their SecureBIT account page or they can input the credit card number each time they make a transaction. Moreover, the customer may choose to designate a certain credit card to pay for all transactions falling in a certain category (i.e., gasoline, supermarkets, restaurants, business expenses, etc.), thereby automatically making these payments upon acceptance of the transaction without having to input the credit card number each time.

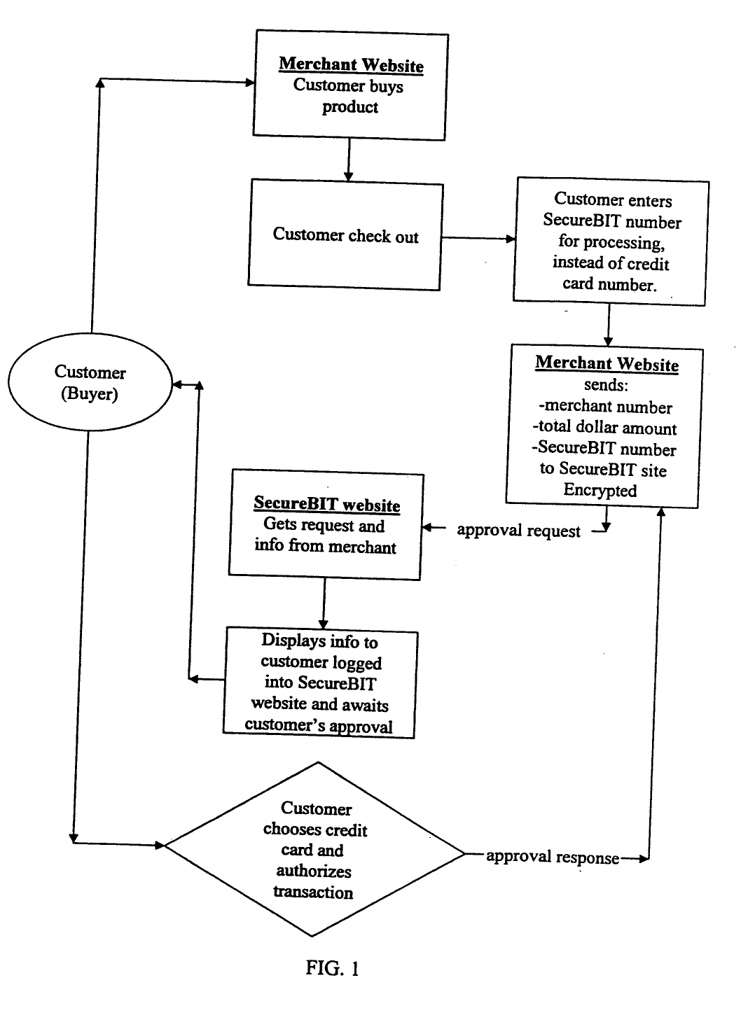

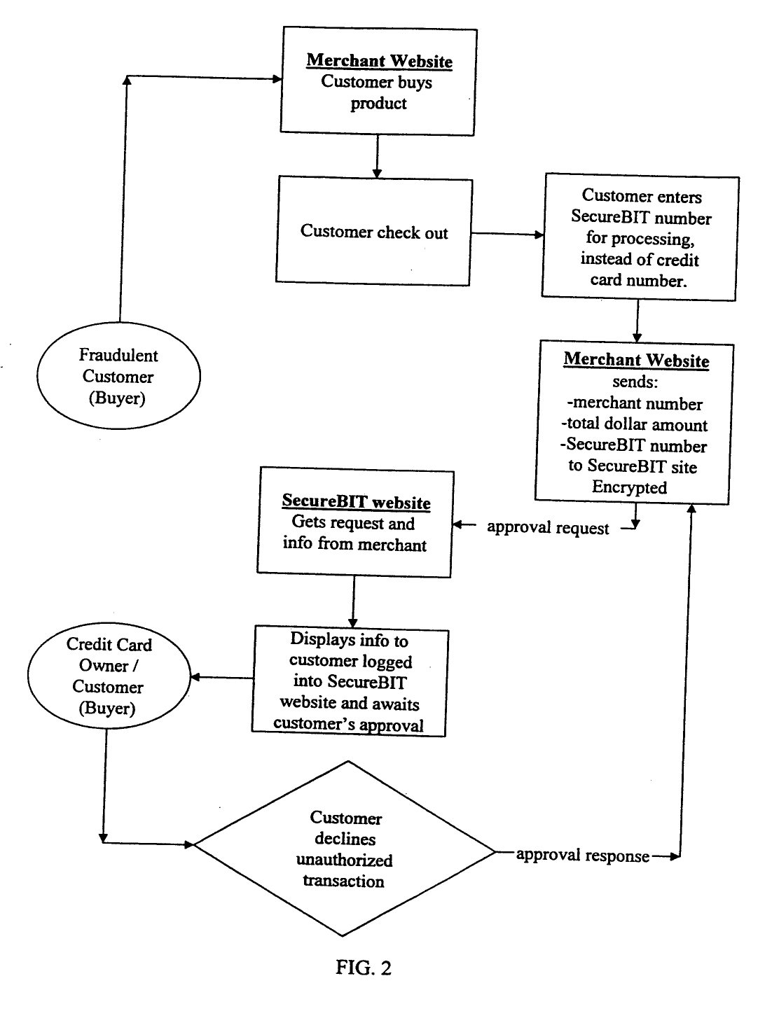

FIGS. 1 and 2 illustrate flow diagrams of the preferred embodiments herein. Steps 1-7 above are illustrated in FIG. 1. In FIG. 2, steps 1-5 above are the same as in FIG. 1. In steps 6 and 7, the fraudulent customer will not be able to login to the SecureBIT website and authorize the transaction, therefore, they will never receive the product or service that they are attempting to purchase. If the real (i.e., valid) credit card owner sees the fraudulent pending transactions, they can decline them, and if they never see the transactions, it will never be accepted until the authorized owner of the credit card accepts the transactions.

There are several advantages of the embodiments herein. Some of the advantages afforded by the embodiments herein to the customer include:
1. Customer only has to go to one central place, SecureBIT website, to key in credit card number and authorize transactions.
2. Customer never has to show credit card number to multiple websites.
3. Customer can see all transactions and accept or decline them if they weren't created by the customer.
4. Customer is able to change SecureBIT number if they feel like someone got their SecureBIT number without their permission, and in no way does it effect their actual credit card numbers.
5. Customer can have multiple SecureBIT numbers per account for tracking different payment categories: bill pay, purchasing products, and recurring monthly credit card charges (i.e. magazine, gym).
6. Customer will receive an email notification when an approval request has been placed by a merchant for a transaction. If they did not make the purchase, they can go to the SecureBIT website right away and decline it.
7. When processing several transactions at one time, the customer only needs to input credit card information once.
8. The ability to have the customer's shipping information stored on the SecureBIT website and sent to the merchant when the transaction is accepted. The customer does not need to fill out their shipping address and other info for multiple transactions on different sites.

Additionally, some of the advantages afforded by the embodiments herein to the merchant include:
1. Will reduce fraud and charge backs significantly.
2. Assured that the transaction is valid because the verified owner of the card will authorize the transaction at the SecureBIT website.
3. Merchant can provide the customer with a speedier checkout process, requiring essentially only the input of the SecureBIT number, with other information gained from the approved transaction, which is less prone to typing mistakes.

The embodiments provide a web based application that utilizes the following hardware/software: servers; secure website with communication to gateways and banking institutions; database software; and system software. In an alternate embodiment, the credit card number could be broken into two encrypted numbers that on there own would not give a third party access to the actual useable number, but when combined securely in a software process and matched with the initiating transaction, result in the real card number, thus hiding it from ordinary display.

The embodiments may be used in banking/fiance and credit card transactions as well as in internet security technologies. Preferably, the embodiments herein will be used by both customers and merchants during the processing of credit card transactions and/or during a verification process to accept or deny access to information. In the case where a customer has multiple credit cards, one SecureBIT number would suffice for the multiple credit card numbers. However, one could also choose to have a SecureBIT number for each credit card. In a non-web transaction, a customer would provide the SecureBIT number under any normal means; i.e., mail, fax, telephone, etc. and the transaction would be verified by a computer connected to the web or by a cell phone/PDA connected to the web or by a cell phone/PDA that can receive/send data to accept or decline a transaction (for example, an encrypted text message).

The embodiments herein can also help parents curb credit card use by their children who have access to the parents' credit cards, whereby each attempted transaction/purchase made by the child has to be accepted/declined by his parent(s) before the transaction/purchase is permitted. In such a case, the parent does not necessarily have to physically be at the same location as the child where the transaction/purchase is being attempted, but rather can accept/decline the transaction from any location.

In an additional embodiment, parent(s) can choose to set a daily limit where they do not have to accept a transaction, and it will be authorized automatically if it is under a certain dollar amount (i.e. $10, $20, etc. or any value set by the parent or authorized user). Thus, if the child needs to use the credit card to buy lunch while at school or gas for the car he may do so. If the parent(s) do not want to be bothered for every transaction, they can set a daily limit and they will only receive notification when the dollar amount is over their specified limit.

In another alternate embodiment, the credit card number could be broken into two encrypted numbers that on there own would not give a lay person access to the actual useable number, but when combined securely in a software process and matched with the initiating transaction, result in the real card number, thus hiding it from ordinary display.

Moreover, as previously mentioned, a cell phone or PDA or other handheld device could be used to receive notification of a pending transaction to be accepted or denied by the customer, by receiving and encrypted text message, that the cell phone/PDA would decrypt using software running on the device, and send back an accepted or denied notice to the SecureBIT site.

Still alternatively, the SecureBIT system can be used to verify any transaction including logging onto company severs and email. When someone logs on to a server, the server sends a notification to the authorized user's SecureBIT account that someone is trying to log into the authorized user's email account (or any other type of account); if it is the authorized user who is attempting to log into the account, then the authorized user can approve it and, has access to the server and email account. If it is not approved (i.e., transaction is declined), then the user would not be able to log on.

The embodiments herein can take the form of an entirely hardware embodiment, an entirely software embodiment or an embodiment including both hardware and software elements. In a preferred embodiment, the invention is implemented in software, which includes but is not limited to firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

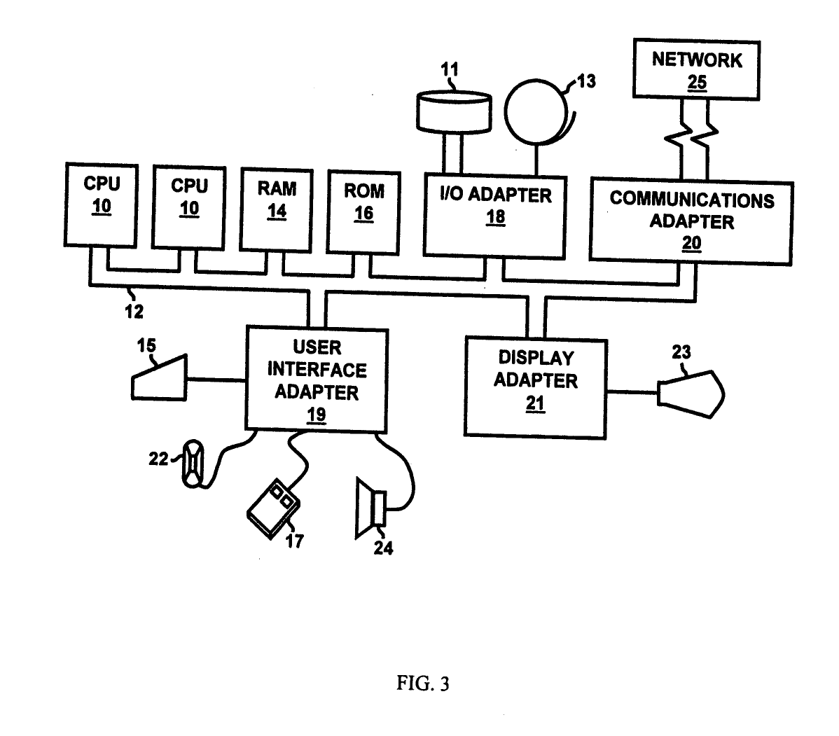

A representative hardware environment for practicing the embodiments of the invention is depicted in FIG. 3. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a RAM 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the descriptions herein.

We claim:

1. A system and method that allows a person to purchase any items without giving control of the exchange of money to the seller of said items; comprising:
a token (number, group of numbers and or letters of any digit length), to be used by said person in place of a credit card number of said person;
an interface that allows said token to be used to identify said person, when said person purchases any item that would normally require a credit card number or other identifier, by which a person could gain information and or money from the possession of said identifier;
an interface that allows said person to view single or multiple requests made for money to cover the purchase of any item, and to approve or deny said requests;
an interface that allows said person to use their credit card to pay the amounts of said requests, to the institutions that have made said requests;
